(19) United States
(12) Patent Application Publication
(10) Pub. No.: US 2017/0326498 A1
(43) Pub. Date: Nov. 16, 2017

(54) Sulfite Preconditioning Systems And Methods To Reduce Mercury Concentrations In Waste Water

(71) Applicant: General Electric Company, Schenectady, NY (US)

(72) Inventors: Raymond Raulfs Gansley, Knoxville, TN (US); Trevor James Dale, Metuchen, NJ (US)

(21) Appl. No.: 15/151,536

(22) Filed: May 11, 2016

(51) Int. Cl. B01D 53/73; B01D 53/64; B01D 53/80; C02F 1/00; C02F 1/52; C02F 1/74; B01D 53/50; C02F 103/18; C02F 101/20

(52) U.S. Cl. CPC B01D 53/73; C02F 1/008; B01D 53/64; B01D 53/80; C02F 1/004; B01D 53/504; C02F 1/5236; C02F 1/74; B01D 2257/302; B01D 2257/602; B01D 2251/404; C02F 2001/007; C02F 2101/20; C02F 2103/18; C02F 2209/00

(57) ABSTRACT

The present application provides a waste water preconditioning system for limiting mercury concentrations in a waste water stream resulting from treatment of a flue gas. The waste water preconditioning system may include a wet flue gas desulfurization system for treating the flue gas with an aqueous alkaline slurry, a sulfite detector to determine the concentration of sulfite in the aqueous alkaline slurry, and to produce the waste water stream with a mercury concentration of less than about five micrograms per liter. The waste water preconditioning system also may include a waste water treatment system downstream of the wet flue gas desulfurization system.

### TECHNICAL FIELD

The present application and the resultant patent relate generally to systems and methods for reducing dissolved mercury in waste water through the control of sulfite concentrations within a wet flue gas desulfurization system. Removing or limiting the levels of dissolved mercury may provide for an improved waste water treatment system downstream thereof.

### BACKGROUND OF THE INVENTION

Combustion of fuel sources such as coal produces a waste gas, referred to as a “flue gas” that is to be emitted into an environment, such as the atmosphere. The fuel sources typically contain sulfur and sulfur compounds that are converted in the combustion process to gaseous species, including sulfur oxides, in the resulting flue gas. The fuel sources typically also contain elemental mercury or mercury compounds that are converted in the combustion process and exist in the flue gas as gaseous elemental mercury or gaseous ionic mercury species.

As such, the flue gas contains particles, noxious substances, and other impurities considered to be environmental contaminants. Prior to emission into the atmosphere via a smoke stack, the flue gas undergoes a cleansing or purification process. In coal combustion, one aspect of this purification process is normally a desulfurization system, such as a wet scrubbing operation commonly known as a wet flue gas desulfurization system.

Sulfur oxides are removed from the flue gas using the wet flue gas desulfurization system by introducing an aqueous alkaline slurry to a scrubber tower. The aqueous alkaline slurry typically includes a basic material that will interact with contaminants to remove them from the flue gas. Examples of basic materials that are useful in the aqueous alkaline slurry include lime, limestone, magnesium salts, sodium hydroxide, sodium carbonate, ammonia, combinations thereof and the like.

There has been an increased focus in the treatment of flue gas on the removal of mercury. Presently, there are various methods for removing mercury from the flue gas. These methods include the addition of oxidizing agents in a boiler upstream of the flue gas emission control system and then removing the oxidized mercury with scrubbers, the addition of absorbents or chemicals to bind the mercury and removing the same from the flue gas, and the utilization of particular coals or fuels to minimize the amount of mercury released when the coal or fuel is burned.

A number of generally known methods of mercury removal are effective to produce mercury salts, which can be dissolved and removed by the aqueous alkaline slurry used in the wet scrubbing operation. Some of these methods include the addition of halogen or halogen compounds, such as bromine, to the coal or to the flue gas upstream of the wet scrubbing operation to provide oxidation of elemental mercury to ionic mercury and formation of mercury salts, which are then dissolved in the aqueous alkaline slurry incident to the sulfur oxide removal processes. However, the removal of mercury in the aqueous alkaline slurry of a wet scrubber has proven to be difficult to control in some cases as the dissolved oxidized mercury can be reduced in the slurry and volatilized as elemental mercury. The desired emission guarantee levels are often as low as about 0.3 μg/Nm³ of mercury, which corresponds to a very high mercury removal efficiency in the wet scrubber.

### SUMMARY OF THE INVENTION

The present application and the resultant patent thus provide a waste water preconditioning system for limiting mercury concentrations in a waste water stream resulting from treatment of a flue gas. The waste water preconditioning system may include a wet flue gas desulfurization system for treating the flue gas with an aqueous alkaline slurry, a sulfite detector to determine the concentration of sulfite in the aqueous alkaline slurry, and to produce the waste water stream with a mercury concentration of less than about five micrograms per liter. The waste water preconditioning system also may include a waste water treatment system downstream of the wet flue gas desulfurization system.

The present application and the resultant patent further provide a method of reducing mercury concentrations in a waste water stream resulting from the treatment of a flue gas. The method may include the steps of treating the flue gas with an aqueous alkaline slurry, maintaining a predetermined concentration of sulfite in the aqueous alkaline slurry, creating the waste water stream from the aqueous alkaline slurry, limiting a dissolved mercury concentration in the waste water stream while increasing a solid mercury concentration in the waste water stream, and forwarding the waste water stream to a waste water treatment system.

The present application and the resultant patent further may provide a method of reducing mercury concentrations in a waste water stream resulting from the treatment of a flue gas. The method may include the steps of treating the flue gas with an aqueous alkaline slurry in a wet flue gas desulfurization system, creating the waste water stream from the aqueous alkaline slurry, preconditioning the waste water stream to limit a dissolved mercury concentration to less than about five micrograms per liter, and forwarding the waste water stream to a waste water treatment system.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a waste water preconditioning system as may be described herein with a wet flue gas desulfurization system and a waste water treatment system.

FIG. 2 is a schematic diagram of the wet flue gas desulfurization system of FIG. 1.

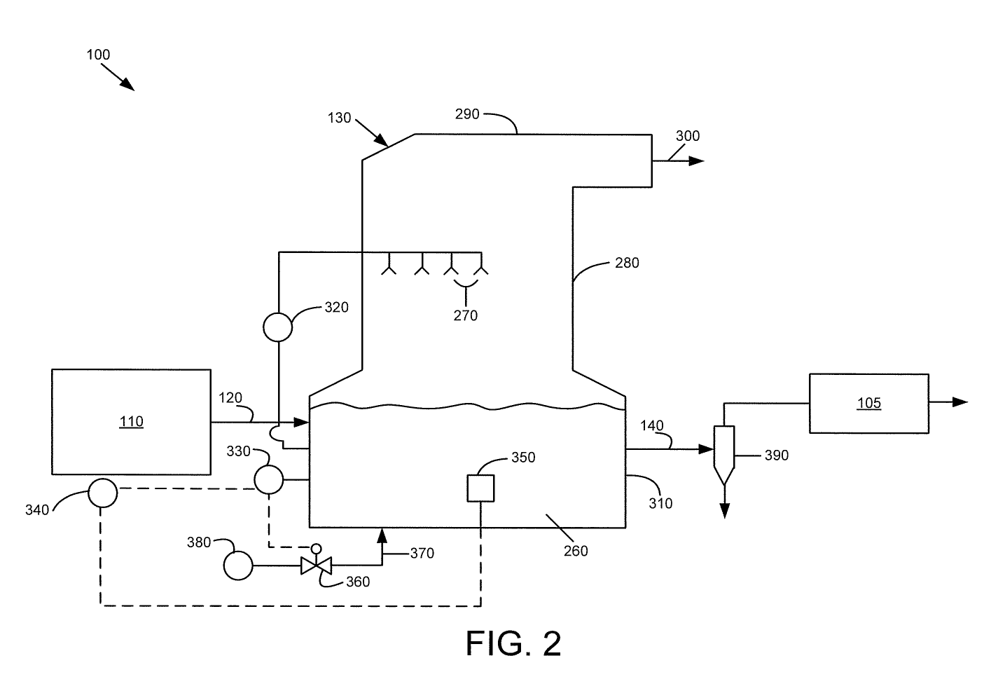

### DETAILED DESCRIPTION

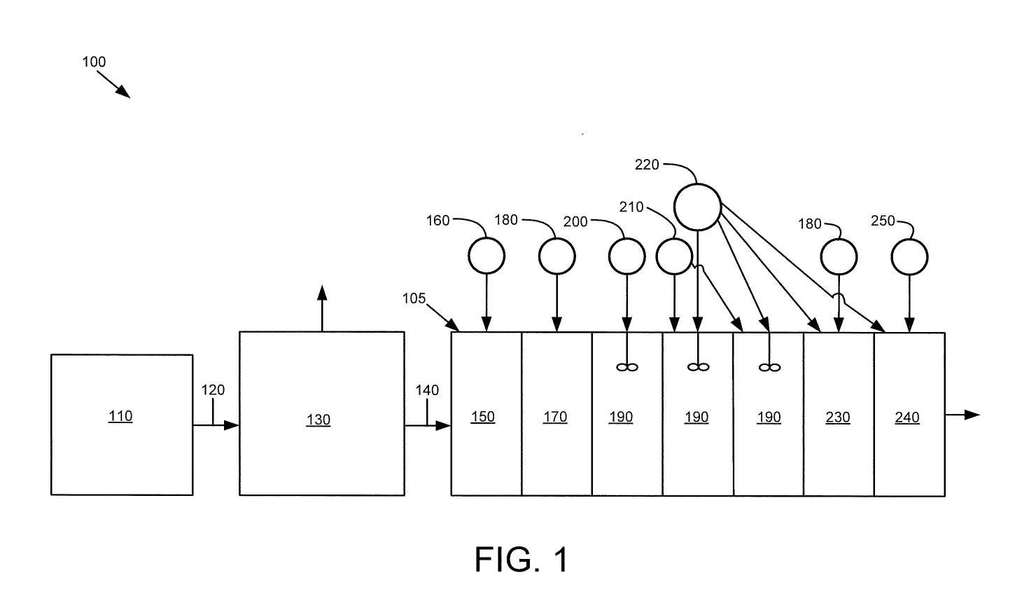

Referring now to the drawings, in which like numerals refer to like elements throughout the several views, FIG. 1 shows a schematic diagram of an example waste water preconditioning system 100. The waste water preconditioning system 100 may include a waste water treatment system (WWTS) 105. The WWTS 105 may be positioned downstream of a boiler 110 producing a flue gas 120 and a wet flue gas desulfurization system (WFGD) 130. The WFGD 130 may produce a flow of waste water 140 that should be processed before further use. Other components and other configurations may be used herein.

Generally described, the WWTS 105 may include a desaturator 150. The desaturator 150 treats the waste water 140 with a flow of lime 160 and the like so as to reduce the tendency of the waste water 140 to scale. The desaturator 150 reduces the concentration of sulfate therein by precipitation of calcium sulfate and the like. The WWTS 105 may include a primary clarifier 170 downstream of the desaturator 150. The primary clarifier 170 may remove suspended solids, including mercury, in the waste water 140. The primary clarifier 170 may add solidifiers 180 such as flocculants and other types of polymers to aid in the removal of solids and the like.

The WWTS 105 may include one or more mix tanks 190 downstream of the primary clarifier 170. The mix tanks 190 may mix pH adjusters 200, coagulators 210, metal precipitants 220, and other additives with the waste water 140. Specifically, certain types of metal precipitants 220 may be effective in reducing the levels of dissolved mercury in the waste water 140. An example of a metal precipitant 220 that may be used herein includes the MetClear® metal precipitant offered by General Electric Company of Schenectady, N.Y. Other types of precipitants and other types of additives also may be used herein. The WWTS 105 also may include a further clarifier 230 and a number of filters 240. The further clarifier 230 largely functions in the same manner as the primary clarifier 170 described above. The filters 240 may have varying sizes and capacities to remove fine materials remaining in the waste water 140. The filters 240 may use a filter aid 250 and the like to improve filtration performance and/or a scale control agent to limit scaling. The WWTS 105 described herein is for the purpose of example only. Many different types of WWTS's and components and configurations thereof may be used herein.

As described above, the WFGD system 130 may be positioned upstream of the WWTS 105 within the waste water preconditioning system 100. Within the WFGD system 130, the flue gas 120 may come into direct contact with an aqueous alkaline slurry 260 so as to remove contaminants therefrom. The aqueous alkaline slurry 260 may be introduced into the WFGD system 130 through one or more nozzles 270 in an upper portion 280 of a scrubber tower 290. The aqueous alkaline slurry 260 aids in removing contaminants such as sulfur oxides and dissolved mercury from the flue gas 120. The removal of such contaminants from the flue gas 120 produces a cleaned flue gas 300. The cleaned flue gas 300 flows out of the WFGD system 130 to a fluidly connected stack (not shown) or other type of emissions control apparatus (not shown). Although the WFGD system 130 is described herein as using the scrubber tower 290 for purposes of clarity, other types of WFGD systems also may be used herein.

The aqueous alkaline slurry 260 may be transported to the nozzles 270 from a collecting tank 310 via one or more pumps 320 and the like. The amount of aqueous alkaline slurry 260 transported to nozzles 270 may depend upon several factors such as, but not limited to, the amount of flue gas 120 present in the scrubber tower 290, the amount of contaminants in the flue gas 120, and/or the overall design of the WFGD system 130. After the aqueous alkaline slurry 260 directly contacts the flue gas 120 and removes the contaminants therefrom, the aqueous alkaline slurry 260 may be collected in the collecting tank 310 for recirculation to the nozzles 270 by the pumps 320.

To reduce overall mercury concentrations, one or more sulfite sensors 330 may be arranged in communication with the aqueous alkaline slurry 260 in the collecting tank 310. The sulfite sensors 330 may measure the sulfite concentration of the aqueous alkaline slurry 260 in the collecting tank 310. The sulfite sensors 330 may measure sulfite concentrations either continuously or at predetermined intervals. For example, predetermined intervals for sulfite concentration measurement may be determined automatically by a control device 340 in communication with the sulfite sensors 330 or manually by a user. The control device 340 may include, for example, but not limited to a computer, a microprocessor, an application specific integrated circuit, circuitry, or any other device capable of transmitting and receiving electrical signals from various sources, at least temporarily storing data indicated by signals, and perform mathematical and/or logical operations on the data indicated by such signals. The control device 340 may include or be connected to a monitor, a keyboard, or other type of user interface, and an associated memory device. Although the use of the sulfite sensors 330 are described herein, the measurement of the sulfite may be made by other means such as on-line or periodic chemical analysis or other methods to provide the sulfite signal. The use of a sensor that provides specific on-line sulfite readings currently may be preferred. The use of the terms sulfite “detector”, “analyzer”, and the like thus are intended to cover the “sensor” and all of these different detection methods.

The control device 340 may compare the measured sulfite concentration(s) to one or more predetermined sulfite concentration values as a set point, which may be stored in the memory device. It is contemplated that the one or more predetermined sulfite concentration potential values may include a single value or a range of values. The predetermined value(s) may be a user-input parameter. For example, the predetermined sulfite concentration values may range from about 300 mg/L to about 500 mg/L or from about 25 mg/L to about 150 mg/L. Other sulfite concentration values may be used herein. By “predetermined,” it is simply meant that the value is determined before the comparison is made with the actual measured sulfite concentration(s) as measured by the sulfite sensors 330.

Optionally, a mercury measurement device 350 also may be used in the subject system to measure mercury concentrations. The mercury measurement device 350 may be any device suitable to measure mercury concentrations from the scrubber tower 290 or elsewhere. Examples include but are not limited to continuous emission monitors (CEMs), such as cold-vapor atomic absorption spectrometry (CVAAS), cold-vapor atomic fluorescence spectrometry (CVAFS), in-situ ultraviolet differential optical absorption spectroscopy (UVDOAS), and atomic emission spectrometry (AES). Other types of sensors may be used herein.

Comparison of the measured sulfite concentration to the one or more predetermined sulfite concentration values may cause the control device 340 to provide a control signal to a valve and/or a blower 360. The valve and/or the blower 360 may adjust an amount of oxidation air 370 that is introduced from a fluidly connected oxidation air source 380 into the aqueous alkaline slurry 260 collected in the collection tank 310. Adjusting the amount of oxidation air 370 introduced to the collecting tank 310 may adjust the sulfite concentration of the aqueous alkaline slurry 260 present therein. The sulfite concentrations may range from about 20 to 50 mg/L, about 5 to 75 mg/L, about 1 to 200 mg/L, about 1 to 400 mg/L, and the like. Other sulfite concentrations may be used herein.

By comparing the measured sulfite concentration to the predetermined sulfite concentration values, the sulfite concentration may be adjusted as desired via the oxidation air 370. As such, it is possible to limit the overall concentration of mercury in the waste water 140 via the control of the sulfite concentrations. It is contemplated that the control device 340 may employ known control algorithms, e.g., proportional, integral, and/or derivative control algorithms, to adjust the control signals in response to the comparison of the measured sulfite concentration and the predetermined sulfite concentration values. Feed forward control schemes also may be used that incorporate other operating parameters available digitally as input to the control device 340 such as inlet SO₂ concentrations, a measure of the gas flow rate or other boiler operating condition such as percent load, and/or other operating conditions. Once treated, the WFGD system 130 produces a volume of the waste water 140 that is forwarded to the WWTS 105 for further processing. An additional separator 390 and the like also may be used to reduce and/or classify by size the suspended solids in the stream sent to the WWTS 105. Other components and other configurations may be used herein.

Mercury present in the aqueous alkaline slurry 260 can be present in high concentrations as dissolved mercury. For example, about 50 to 250 micrograms per liter of mercury may be found in the aqueous phase. When the WFGD system 130 operates with sulfite control, the concentration of dissolved mercury may decrease to a lower level of about ten micrograms per liter or less, about five micrograms per liter or less, or preferably to about one micrograms per liter or less, with a corresponding increase in mercury in the solid phase, particularly prevalent in the fine solids and the like. Mercury in the solid phase thus may be more easily removed downstream in the separator 370 and/or the primary clarifier 170. Solid additives to the WFGD system 130 such as gypsum, limestone, or other solid materials may be used to allow the mercury in the solid form to agglomerate or accumulate with these other materials. Iron or magnesium additives to the WFGD system 130 also may be used to aid in the mercury transition from dissolved to solid form.

The WFGD system 130 thus preconditions the flow of the waste water 140 to precipitate a portion of the mercury into the solid phase upstream of the WWTS 105. One of the key functions of the WWTS 105 is to reduce the mercury concentrations in the waste water 140 to meet discharge requirements. (For example, certain governmental regulations may require a discharge level of less than about 0.356 micrograms per liter.) By preconditioning the waste water 140, the overall size and capacity of the WWTS 105, the components thereof, and the additives used therein all may be reduced. Specifically, the chemical used to aid in solids removal such as flocculants, coagulants, pH adjusters, precipitants, and the like may benefit from lower demands required to meet the mercury requirements. Preconditioning with sulfite control in the WFGD system 130 thus provides a more steady and consistent chemistry for the waste water 140 stream in the WWTS 105. Such consistency may improve overall WWTS 105 operation with a resultant reduction in manpower required for testing and system adjustments. Moreover, the chemical volumes may be decreased so as to provide reduced overall operating costs and reduced component size and/or capacity.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A waste water preconditioning system for limiting mercury concentrations in a waste water stream resulting from treatment of a flue gas, comprising:
a wet flue gas desulfurization system for treating the flue gas with an aqueous alkaline slurry;
the wet flue gas desulfurization system comprising a sulfite detector to determine the concentration of sulfite in the aqueous alkaline slurry;
the wet flue gas desulfurization system producing the waste water stream with a mercury concentration of less than about five micrograms per liter; and
a waste water treatment system downstream of the wet flue gas desulfurization system.

2. The waste water preconditioning system of claim 1, wherein the wet flue gas desulfurization system comprises a collecting tank with the aqueous alkaline slurry therein.

3. The waste water preconditioning system of claim 2, wherein the sulfite detector comprises a sulfite sensor to determine the concentration of sulfite in the collecting tank.

4. The waste water preconditioning system of claim 2, further comprising an oxidation air source in communication with the aqueous alkaline slurry in the collecting tank.

5. The waste water preconditioning system of claim 4, wherein the oxidation air source is in communication with the aqueous alkaline slurry in the collecting tank via a valve and/or a blower.

6. The waste water preconditioning system of claim 5, wherein a signal from the sulfite detector controls the valve and/or the blower based upon the concentration of sulfite in the aqueous alkaline slurry in the collecting tank.

7. The waste water preconditioning system of claim 2, wherein the wet flue gas desulfurization system comprises a mercury measurement device in communication with the aqueous alkaline slurry in the collecting tank.

8. The waste water preconditioning system of claim 1, wherein the wet flue gas desulfurization system producing the waste water stream with a mercury concentration of less than about one microgram per liter.

9. The waste water preconditioning system of claim 1, wherein the waste water treatment system comprises one or more clarifiers, filters, or other solid-liquid separation devices.

10. The waste water preconditioning system of claim 1, wherein the waste water treatment system comprises one or more mixing tanks with a metal precipitant added therein.

11. A method of reducing mercury concentrations in a waste water stream resulting from treatment of a flue gas, comprising:
treating the flue gas with an aqueous alkaline slurry;
maintaining a predetermined concentration of sulfite in the aqueous alkaline slurry;
creating the waste water stream from the aqueous alkaline slurry;
limiting a dissolved mercury concentration in the waste water stream while increasing a solid mercury concentration in the waste water stream; and
forwarding the waste water stream to a waste water treatment system.

12. The method of reducing mercury concentrations of claim 11, wherein the step of maintaining a predetermined concentration of sulfite in the aqueous alkaline slurry comprises comparing a measured concentration of sulfite in the aqueous alkaline slurry with the predetermined concentration of sulfite in the aqueous alkaline slurry.

13. The method of reducing mercury concentrations of claim 11, wherein the step of maintaining a predetermined concentration of sulfite in the aqueous alkaline slurry comprising varying a flow of oxidizing air to the aqueous alkaline slurry.

14. The method of reducing mercury concentrations of claim 11, further comprising the step of removing the solid mercury from the waste water stream in one or more clarifiers, filters, or other solid-liquid separation devices in the waste water treatment system.

15. The method of reducing mercury concentrations of claim 11, wherein the step of treating the flue gas with an aqueous alkaline slurry comprises treating the flue gas in a wet flue gas desulfurization system.

16. A method of reducing mercury concentrations in a waste water stream resulting from treatment of a flue gas, comprising:
treating the flue gas with an aqueous alkaline slurry in a wet flue gas desulfurization system;
creating the waste water stream from the aqueous alkaline slurry;
preconditioning the waste water stream to limit a dissolved mercury concentration to less than about five micrograms per liter; and
forwarding the waste water stream to a waste water treatment system.

17. The method of reducing mercury concentrations in a waste water stream of claim 16, wherein the step of preconditioning the waste water stream comprises maintaining a predetermined concentration of sulfite in the aqueous alkaline slurry.

18. The method of reducing mercury concentrations of claim 17, wherein the step of maintaining a predetermined concentration of sulfite in the aqueous alkaline slurry comprises comparing a measured concentration of sulfite in the aqueous alkaline slurry with the predetermined concentration of sulfite in the aqueous alkaline slurry.

19. The method of reducing mercury concentrations of claim 17, wherein the step of maintaining a predetermined concentration of sulfite in the aqueous alkaline slurry comprising varying a flow of oxidizing air to the aqueous alkaline slurry.

20. The method of reducing mercury concentrations of claim 16, wherein the step of preconditioning the waste water stream comprises limiting a dissolved mercury concentration in the waste water stream while increasing a solid mercury concentration in the waste water stream.
